(19) United States
(12) Patent Application Publication
(10) Pub. No.: US 2010/0197181 A1
(43) Pub. Date: Aug. 5, 2010

(54) Underwater buoy system

(76) Inventor: Carl Wainman, Cape Town (ZA)

Correspondence Address: Goodwin Procter LLP;Attn: Patent Administrator, 135 Commonwealth Drive, Menlo Park, CA, 94025-1105, US

(21) Appl. No.: 12/524,917

(22) PCT Filed: Jan. 31, 2008
(86) PCT No.: PCT/IB2008/050337

§ 371 Date: Mar. 29, 2010

(30) Foreign Application Priority Data
Jan. 31, 2007 (ZA) 2007/00970

(51) Int. Cl. B63B 22/18; B63B 22/20; G08C 19/16

(52) U.S. Cl. 441/24; 340/870.01

(57) ABSTRACT

An underwater buoy system is disclosed. The system comprises a docking station (10) arranged to receive a buoy (14), and a reservoir (20) of gas under pressure with a first controllable valve (24) operable to release gas from the reservoir selectively. A buoy is received by the docking station and has a flotation chamber enabling the buoy to be rendered positively buoyant by gas released from the reservoir so that it ascends. The buoy has a second controllable valve (52) for venting gas from the flotation chamber to render the buoy negatively buoyant so that it sinks, and a retraction mechanism (35) having a line attached to the buoy and which is arranged to pay out line as the buoy ascends and to retract the line when the buoy sinks. A control system (48) actuates the first controllable valve at predetermined intervals or when sensor data is received which meets or exceeds a predetermined value. The second valve is typically actuated after a predetermined time, sufficient to allow the buoy to transmit data to a monitoring station.

### BACKGROUND OF THE INVENTION

THIS invention relates to an underwater buoy system comprising an underwater docking station and a controllable buoy.

Equipment for taking underwater environmental measurements, such as sea floor and water property measurements, amongst others, is required for a wide variety of applications such as environmental management and monitoring, disaster management, early warning systems, scientific research and many others.

Conventionally, such underwater measurements are carried out using moored platforms such as anchored moorings with a surface marker buoy or shore attached data cable, or free floating buoys. Moored platforms are relatively expensive and cumbersome and are vulnerable to weather and environmental conditions. On the other hand, free floating buoys tend to drift out of the area of interest over time.

It is an object of the invention to provide an alternative underwater buoy system.

### SUMMARY OF THE INVENTION

According to the invention there is provided an underwater buoy system comprising:
a housing defining a docking station arranged to receive a buoy;
a reservoir of gas under pressure;
a first controllable valve operable to release gas from the reservoir selectively;
a buoy arranged to be received by the docking station and having a flotation chamber enabling the buoy to be rendered positively buoyant by gas released from the reservoir so that it ascends, the buoy further having a second controllable valve for venting gas from the flotation chamber to render the buoy negatively buoyant so that it sinks;
a retraction mechanism having a line attached to the buoy and arranged to pay out line as the buoy ascends and to retract the line when the buoy sinks; and
a control system arranged to actuate the first controllable valve in response to one or more predetermined events.

The control system may, for example, include a timer and be arranged to actuate the first controllable valve at predetermined intervals.

Alternatively, or in addition, the control system may be arranged to receive inputs from one or more sensors and to actuate the first controllable valve when sensor data is received which meets or exceeds a predetermined value.

The retraction mechanism preferably comprises a mechanical drive, such as a constant force spring drive, arranged to apply a substantially constant retraction force to the buoy via the line.

The volume of the flotation chamber in the buoy and the amount of gas released by the first controllable valve are preferably selected to ensure that the positive buoyancy of the buoy overcomes the retraction force applied by the retraction mechanism by a predetermined margin.

The buoy preferably has a control system which is arranged to operate the second controllable valve to release gas from the internal flotation chamber after a predetermined time or on detection of a predetermined event.

The buoy is preferably part of a data telemetry system, the buoy containing a transmitter for transmitting data to a remote station from the surface of a body of water.

Preferably, the buoy has a short range transceiver for receiving data from the buoy platform, for onward transmission to the remote station.

The buoy may include a sensor input arranged to receive data from one or more sensors associated with the buoy.

The control system preferably includes at least one sensor input arranged to receive data from one or more sensors associated with the docking station, data storage means for storing received data, and a short range transceiver for transmitting the stored data to the buoy for onward transmission to the remote station.

The control system of the docking station may operate to upload data to the buoy and actuate the first controllable valve after a predetermined time period has elapsed since a previous operation, and/or when sensor data meeting predetermined criteria is received.

For example, sensor data indicating an event exceeding a predetermined magnitude may trigger activation of the buoy and transmission of the received data to the remote station.

### BRIEF DESCRIPTION OF THE DRAWINGS

FIG. 1 is a schematic diagram showing major components of an underwater buoy system according to the invention;

FIG. 2 is a partial sectional side view of an embodiment of the buoy system of FIG. 1; and

FIGS. 3(a) to (f) are diagrammatic illustrations showing the operation of the system in use.

### DESCRIPTION OF EMBODIMENTS

The present invention provides an underwater buoy system which utilises an underwater docking station with a tethered buoy which can be released periodically for ascent to the surface of a body of water, where it is able to transmit data to a remote monitoring station, and then be retracted to its original position.

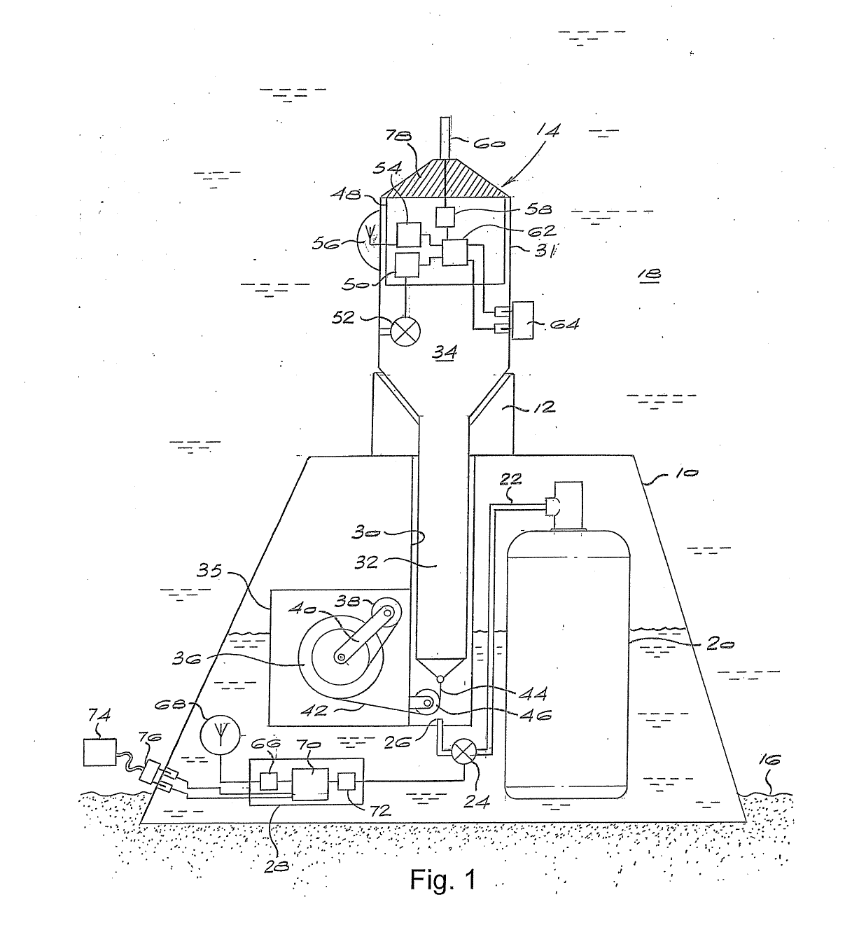

Referring to FIG. 1, an embodiment of an underwater buoy system according to the invention is illustrated schematically. The system comprises an underwater housing or docking station 10 defining a docking port 12 for a buoy 14. The docking station is weighted so that it rests firmly on the sea bed 16 (or another support or substrate under the surface of the water 18). The housing will be constructed from corrosion and bio-fouling resistant material.

Within the housing 10 is a cylinder 20 of compressed air. A hose or pipe 22 connects an outlet of the cylinder to a controllable pillar-type valve 24 which has an outlet 26. The valve 24 is controlled by a solenoid or a servomotor, for example, which is in turn controlled by a control circuit 28 (discussed in greater detail below).

The buoy has a head portion 31 of relatively large diameter and a tail portion 32 depending from the head and having a relatively small diameter. A buoyancy chamber 34 is defined within the head of the buoy and communicates with an opening at the lowermost end of the tail portion 32. The docking port 12 defines a conical surface for receiving the head of the buoy 14 and a downwardly extending bore 30 that receives the tail portion 32 of the buoy. The outlet 26 of the valve 24 is located at the lower end of the bore 30.

Adjacent to the bore 30 is a buoy retraction mechanism 35 comprising a reel 36 arranged to be driven by a mechanical drive, preferably a constant force spring drive 38. Both the reel and the spring drive are supported on a frame 40. A line 42 comprising a length of non ferrous wire, such as copper wire, or a synthetic line is wound on the reel 36, and one end 44 of the line passes over a pulley 46 and is attached to the lower end of the buoy 14. Instead, the line could be connected directly to the buoy. The length of the line 42 will be determined by the intended application of the buoy system, and must be long enough for the buoy to ascend to the surface of the body of water 18 in use.

In the prototype system the retraction mechanism was built from plastics materials, with the main spring of the constant force spring drive being formed from a flat strip of marine grade (for example 304, 314 or 316) stainless steel. The materials of the buoy system, and the retraction mechanism in particular, are selected to be resistant to salt water corrosion and bio-fouling.

Within the head of the buoy 14, above the buoyancy chamber 34, a control circuit 48 is provided, including a valve control circuit 50 for controlling the operation of a second controllable valve 52, a short range transceiver 54 with an associated antenna 56 for communicating with a transceiver and associated antenna of the docking station. The control circuit 48 further includes a transmitter 58 with an associated antenna 60 for transmitting data to a remote data logging station. The circuit includes a control module 62, typically microprocessor based, which is arranged to receive an input from a buoy sensor module 64 which can be connected to the buoy itself if required. The sensor module 64 can be used, for example, for taking temperature readings or the like as the buoy ascends or descends in use.

Fixed flotation material 78 is provided in the head of the buoy to partially counteract the mass of the buoy and its components, to reduce the amount of buoyancy needed from the air in the buoyancy chamber in use.

The control circuit 28 of the docking station includes a short range transceiver 66 with an associated antenna 68, for transmitting data to and receiving data from the buoy, a main microprocessor based control circuit 70 and a valve control circuit 72 which controls the operation of the first controllable valve 24. One or more external sensors 74 can be connected to the control circuit 28 by means of suitable cables 76 and allow the docking station to receive and record sensor data relating to water temperature, turbidity, salinity, productivity, dissolved oxygen, etc. Acoustic, electrical, or optical sensors can be provided for sensing events such as seismic events, wave activity, and water level amongst many others. It will be appreciated that the above examples are merely some of many possible sensors and sensing applications and that the system could also be used in fresh water or any suitable fluid environment.

In a typical application of the buoy system, the main control circuit 28 is programmed to cause the buoy to ascend when a predetermined event occurs. This could be the elapsing of a predetermined time interval, typically 12 hours, and/or the occurrence of a predetermined event as detected by the associated sensors. For example, one of the sensors 74 may detect a seismic event greater than a predetermined threshold, in which case the control circuit 28 immediately triggers operation of the buoy.

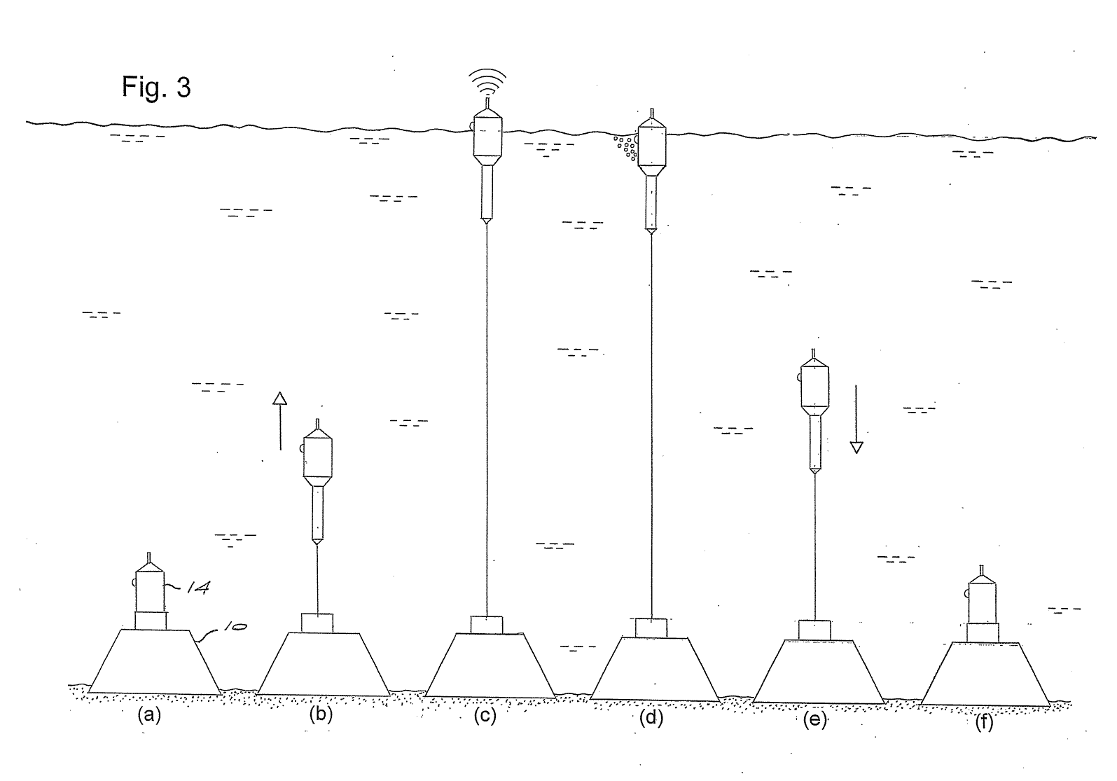

The data collected by the control circuit 70 is transmitted via the transceiver 66 and the antenna 68 to the antenna 56 and transceiver 54 of the buoy, where it is stored temporarily for uploading to the remote logging station. The valve control circuit 72 operates the valve 24, which releases a predetermined volume of air (typically about 5 litres) which fills the floatation chamber 34 and creates a positive buoyancy which overcomes the force of the retraction mechanism and causes the buoy to ascend (see FIG. 3(b)).

When the buoy reaches the surface, the transmitter 58 transmits the stored data which will generally be data obtained from the sensors mentioned above, including images. The data is received by the remote logging station. Either after a predetermined period of time, sufficient to transmit the necessary data, or after the control circuit 62 detects that the data has been transmitted, the valve control circuit 50 is operated to open the valve 52, purging the buoyancy chamber 34 so that the buoy has negative or only slight positive buoyancy, and allowing the retracting mechanism 34 to retract the line 42 and thus to return the buoy to its position on the docking station.

In addition to the transmission of data as described above, or in some cases, instead of such data transmission, the buoy system may cause a warning or signaling device to be operated, which could be a radio transmitter, a light or strobe, a smoke generator, a flare or the like. The operation of such a warning device can be detected by observers independently of the remote logging station, and could be used to give a warning of an event such as, for example, a tsunami or a seismic event.

While ascending and/or descending, the buoy can record data by means of the sensor 64. For example, the buoy can record a temperature profile in the body of water 18.

In the prototype system, a conventional 12 litre scuba tank filled with compressed air at a pressure of 200 bar was used. This corresponds to a volume of 1698 litres of air at 1 bar (the air pressure at sea level). Assuming that 4.5 litres of air is used for each ascent, then 377 ascents are possible with one cylinder, which equates to approximately 2 ascents per day for six months. Thus, assuming that the electronics in the docking station and buoy are provided with suitable batteries having an equivalent life, the buoy system can be deployed and left unattended for up to six months or longer, dependent on the number of ascend/descend cycles and the resultant air usage.

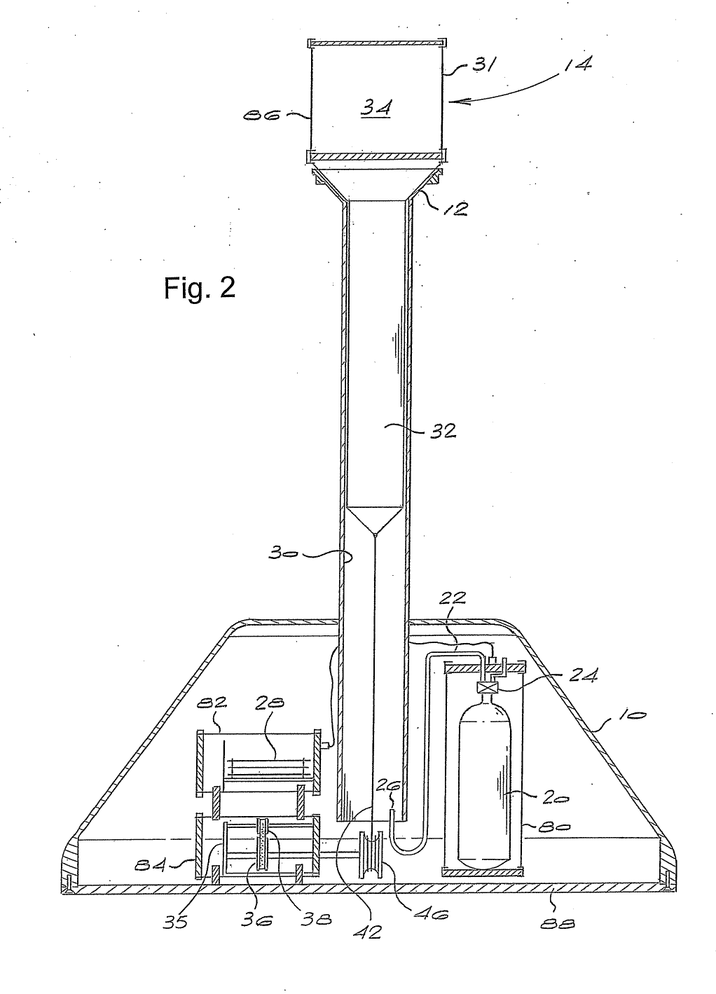

FIG. 2 shows, in a partial sectional side view, constructional details of an example embodiment of a buoy system of the invention. The buoy system as illustrated in FIG. 2 corresponds largely to the schematic diagram of FIG. 1, and corresponding components of the system are numbered accordingly.

In this embodiment, the important components of the system are located within sealed housings which can be, for example, fibre wound canisters with sealable ends. Thus, the compressed air cylinder 20 is located within a sealed housing 80, the control circuit 28 and other electronic circuits are located within a housing 82, and the buoy retraction mechanism 35 is located within a housing 84. The head portion 31 of the buoy is itself formed from a sealed container 86.

The housing 10 has a base plate 88 which is secured to the main portion of the housing by screws or other fasteners, making it possible to seal the housing 10 if required. Alternatively, the housing can be allowed to fill partially with water as indicated in FIG. 1, with the internal components of the system being protected by the water tight enclosures.

Due to the fact that the buoy is retracted below the water surface when not actually transmitting data to the remote station, it is protected from extreme weather conditions, surface gravity wave action and the effects of marine wear and tear, and is not susceptible to the problem of drift as is experienced with non-tethered buoys.

It will be appreciated that the embodiment of the buoy system described above is purely exemplary and that the design, construction and method of operation of the system can be varied according to requirements.

1. An underwater buoy system comprising:
a housing defining a docking station arranged to receive a buoy;
a reservoir of gas under pressure;
a first controllable valve operable to release gas from the reservoir selectively;
a buoy arranged to be received by the docking station and having a flotation chamber enabling the buoy to be rendered positively buoyant by gas released from the reservoir so that it ascends, the buoy further having a second controllable valve for venting gas from the flotation chamber to render the buoy negatively buoyant so that it sinks;
a retraction mechanism having a line attached to the buoy and arranged to pay out line as the buoy ascends and to retract the line when the buoy sinks; and
a control system arranged to actuate the first controllable valve in response to one or more predetermined events.

2. The underwater buoy system of claim 1 wherein the control system includes a timer and is arranged to actuate the first controllable valve at predetermined intervals.

3. The underwater buoy system of claim 1 wherein the control system is arranged to receive inputs from one or more sensors and to actuate the first controllable valve when sensor data is received which meets or exceeds a predetermined value.

4. The underwater buoy system of claim 1 wherein the retraction mechanism comprises a mechanical drive arranged to apply a retraction force to the buoy via the line.

5. The underwater buoy system of claim 4 wherein the volume of the flotation chamber in the buoy and the amount of gas released by the first controllable valve are selected to ensure that the positive buoyancy of the buoy overcomes the retraction force applied by the retraction mechanism by a predetermined margin.

6. The underwater buoy system of claim 1 wherein the buoy has a control system which is arranged to operate the second controllable valve to release gas from the internal flotation chamber after a predetermined time or on detection of a predetermined event.

7. The underwater buoy system of claim 1 wherein the buoy is part of a data telemetry system, the buoy containing a transmitter for transmitting data to a remote station from the surface of a body of water.

8. The underwater buoy system of claim 7 wherein the buoy has a short range transceiver for receiving data from the buoy platform, for onward transmission to the remote station.

9. The underwater buoy system of claim 1 wherein the buoy includes a sensor input arranged to receive data from one or more sensors associated with the buoy.

10. The underwater buoy system of claim 1 wherein the control system includes at least one sensor input arranged to receive data from one or more sensors associated with the docking station, data storage means for storing received data, and a short range transceiver for transmitting the stored data to the buoy for onward transmission to the remote station.

11. The underwater buoy system of claim 10 wherein the control system of the docking station is operable to upload data to the buoy and actuate the first controllable valve after a predetermined time period has elapsed since a previous operation, and/or when sensor data meeting predetermined criteria is received.

12. The underwater buoy system of claim 11 wherein the control system is responsive to sensor data indicating an event exceeding a predetermined magnitude to trigger activation of the buoy and transmission of the received data to the remote station.
